(19) United States
(12) Patent Application Publication
(10) Pub. No.: US 2010/0133069 A1
(43) Pub. Date: Jun. 3, 2010

(54) CONVEYOR BELT MODULE

(75) Inventors: Jean-Philippe Senn, Le Landeron (CH); Friedrich Durand, Ruttenen (CH); Manfred Baer, Vohrenbach (DE)

Correspondence Address: GRIFFIN & SZIPL, PC, SUITE PH-1, 2300 NINTH STREET, SOUTH, ARLINGTON, VA, 22204, US

(73) Assignee: ETA SA MANUFACTURE HORLOGÈRE SUISSE, Grenchen (CH)

(21) Appl. No.: 12/627,158

(22) Filed: Nov. 30, 2009

(30) Foreign Application Priority Data
Nov. 28, 2008 (EP) 08020774.9

(51) Int. Cl. B65G 37/00

(52) U.S. Cl. 198/583

(57) ABSTRACT

The present invention relates to a transport belt module with a body on which at least a deflecting roller and another deflecting element are rotatably mounted, around which a conveyor belt is guided, as well as drive means for driving at least the deflecting roller that is arranged in the body, whereby the module further comprises mechanical and electrical connection elements for connecting the module to a conveyor system or a production line, and also comprises at least a sensor, that is arranged under the conveyor belt so that the objects which are to be transported on the conveyor belt can be detected with the help of the sensor.

This application claims priority from European Patent Application No. 08020774.9 filed Nov. 28, 2008, the entire disclosure of which is incorporated herein by reference.

### FIELD OF THE INVENTION

The present invention deals with a transport belt module for integration in a conveyor system or a production line, particularly for integration in a modular production line as described in the patent application EP07123174 of the same applicant. Priority of this patent application is claimed, and herewith it is referred explicitly to the contents of this patent application. Production lines with conveyor belts are used nowadays almost every industry branch, especially in the electronics and automobile industry, but also for watch making.

### BACKGROUND OF THE INVENTION

Usually, in a production line a plurality of conveyor belt segments are used, which are assembled as a conveyor belt. The individual conveyor belts run around rotatable deflecting rollers, among which at least one is respectively driven. Depending on the type of the production line, mounting units, feeding units for feeding the pieces, sensors and in most cases a central control are foreseen, which work together with the conveyor belts.

Conveyor belts must be regularly changed when signs of wear appear. This is very complex and costly for conventional production lines; most of the time, the entire production must be stopped in order to change the conveyor belt.

### SUMMARY OF THE INVENTION

It is therefore an aim of the invention to provide a possibility to make a rapid and simple change of a conveyor belt segment possible.

This is solved according to the invention thanks to a conveyor belt module according to claim 1.

The conveyor belt module has a body on which at least a deflecting roller and another deflecting element are rotatably mounted, around which a conveyor belt is guided, as well as drive means for driving at least the deflecting roller. The driving means are arranged in the body. The module further comprises mechanical and electrical connection elements for connecting the module to a conveyor system or a production line, and also comprises at least a sensor. The sensor is arranged under the conveyor belt such that the objects which are to be transported on the conveyor belt can be detected with the help of the sensor.

The mechanical and electrical connection elements can be for example bushings, in which suitable electrical contact plugs can be inserted. The module can be supplied with electrical power through these connection elements, and command signals can be transmitted from an external unit to the conveyor belt module. At the same time, the signals detected by the sensor integrated in the module can be transmitted to an external control unit.

When the conveyor belt or also another component of the module must be replaced, the whole module can be replaced with few manipulations. It is enough to separate the mechanical connections from the electrical connections realised by the connection elements, to extract the module, insert a new module, and realise the connections again with the new module. During this process the production line must not necessarily be stopped.

The module removed from the production line can then be repaired without any time constraints; a mounted conveyor belt can for example be disassembled and replaced by a new belt.

According to a preferred embodiment of the invention, the conveyor belt module comprises a plurality of sensors. Preferably one of the sensors is an RFID-reader. RFID-transponders can be mounted on the work piece carriers or the work piece themselves, in which data concerning the production are stored. The RFID-reader can read those data and transmit them to an external control unit, which can issue a corresponding order, depending on those data, to the conveyor belt module, to a gate located above the conveyor belt module, or to a production unit.

A writing unit could also be integrated in the conveyor belt module, which could modify data that would be stored in a memory incorporated into a work piece.

According to a preferred embodiment of the invention, the deflecting shaft is firmly clamped in the body on both sides outside the conveyor belt, and spaced apart sliding bushings are rotatably mounted on the deflecting shaft, wherein the deflecting shafts are supported on support elements intervening between the sliding bushings. Such a deflection of a conveyor belt is already known from the German patent application number 10 2006 038 185.8, to which it is herewith explicitly referred. The deflection over a deflecting shaft with spaced apart rotatably mounted sliding bushings and support elements there-between allows to keep a very small radius for the deflection, and yet to maintain a robust deflection and little susceptible to wear.

The sliding bushings can be made of plastic, metal coated with PTFE and/or graphite or bronze.

According to a preferred embodiment of the invention, the conveyor belt has at least two additional deflecting rollers around which a second conveyor belt is guided, which runs substantially parallel to the first conveyor belt. This yields a two-tracks conveyor belt module, which is advantageous for certain applications. Preferably, separate drive means are foreseen for each of the two conveyor belts. In principle, it is nevertheless also conceivable to have both conveyor belts driven by common driving means, whereby in this case coupling elements must be foreseen, in order to allow for different drive directions or different band speeds for both bands.

In principle, not only the first drive means but also the second optional drive means can consist of a simple drive motor, which drives the transport belt with a constant speed. It is yet also possible to provide drive means with variable speed and/or two drive directions. When two parallel conveyor belts are foreseen, those belts are preferably driven in opposite directions.

### BRIEF DESCRIPTION OF THE DRAWINGS

In the following of this document, the invention is described more in detail with the help of a preferred variant embodiment and in view of the enclosed drawings, which show:

FIG. 1: a perspective view from a conveyor belt seen from above,

FIG. 2: a perspective view from the conveyor belt from FIG. 1 seen from below.

### DETAILED DESCRIPTION OF THE PREFERRED EMBODIMENTS

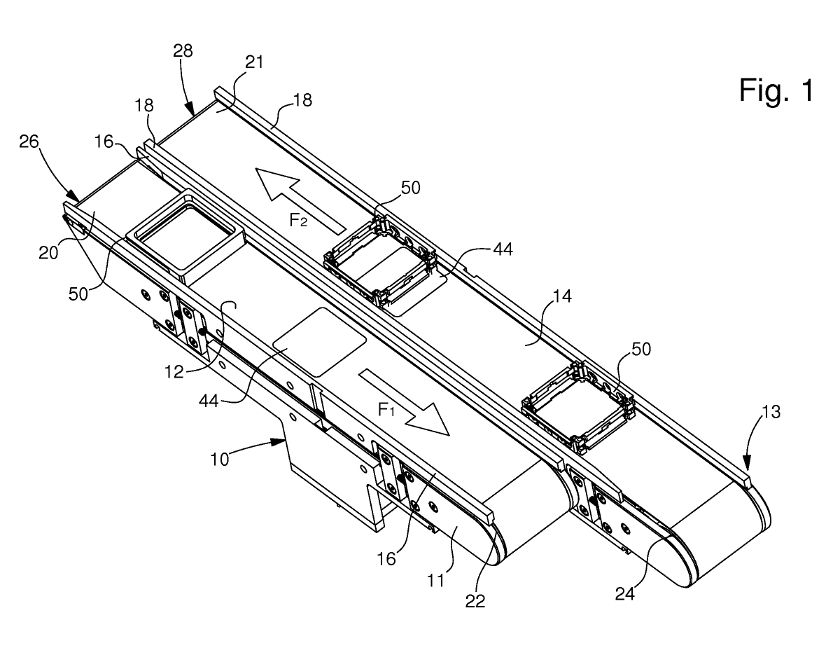

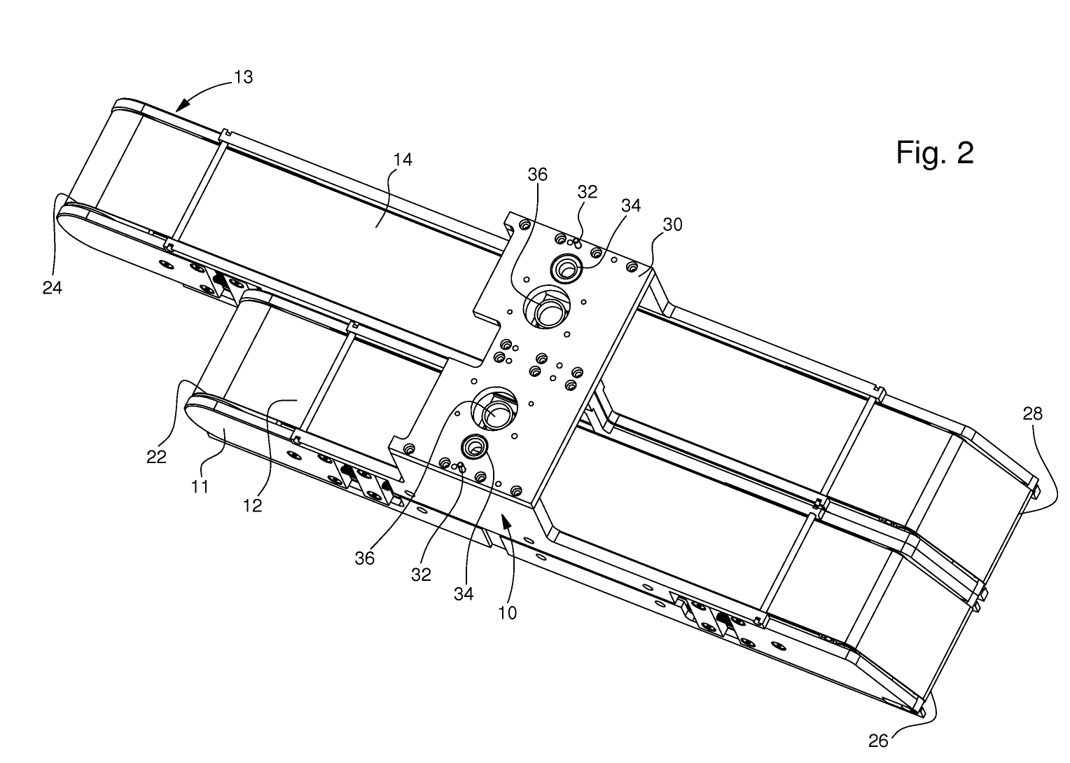

FIG. 1 shows a perspective view of a conveyor belt module for integration in a modular production line seen from above. The conveyor belt module has a body 10 that is bordered by two side walls 11, 13 in the longitudinal direction. The conveyor belt module illustrated in FIGS. 1 and 2 is double-track, i.e. it has two conveyor belts 12,14 running parallel to each other and to the side walls 11, 13.

On FIG. 1, three exemplary work piece carriers 50 are illustrated, which have substantially the form of a plate with a frame surrounding a square surface, and which are transported on the conveyor belts 12, 14. Each conveyor belt 12, 14 is just wide enough for a work piececarrier 50. On the external sides of the conveyor belts 12, 14, boundary bars 16 and 18 serve respectively to guide the work piece carriers 50 in the conveying direction F1, F2 on belts 12 and 14.

The conveyor belt 14 located on the right, and respectively at the back of FIG. 1 is longer as the conveyor belt 12 located in front, respectively on the left. While both conveyor belts 12, 14 terminate jointly perpendicularly to the conveying directions F1, F2 on the left side of FIG. 1, the longer conveyor belt 14 protrudes over the shorter belt on the other side 12. Of course, two equally long belts or any other arrangement with two belts of a different length could be chosen for a double-track conveyor belt module.

Both conveyor belts 12, 14 are driven respectively at one end (in FIG. 1 on the right) around a deflecting roller 22, 24, that is rotatably mounted on the body 10.

On the other side (FIG. 1 left), both conveyor belts 12, 14 are driven around a very thin deflecting shaft 26,28 compared to the deflecting rollers 22, 24 with rotatably mounted bushings on them (not visible on the figures), such that a transfer tongue 20, respectively 21 is formed. The deflecting rollers 26, 28 themselves are not rotatably mounted on the body 10, but fixedly clamped in the body 10. More precisely, the deflecting shaft 26, around which the first conveyor belt 12 is driven, is clamped between the left side wall 11 of the body and a middle wall, while the deflecting shaft 28, around which the first conveyor belt 14 is driven, is clamped between the right side wall 13 of the body and a middle wall. Several sliding bushing respectively spaced apart are rotatably mounted on the deflecting shafts 26,28. Between the not illustrated sliding bushings, also not illustrated support elements are foreseen, which are meant to prevent the bending of the deflecting shafts 26, 28. Such a deflecting type is described more in detail in the already mentioned german patent application number 10 2006 038 185.8 filed Aug. 14, 2006 in the name of IWB Industrietechnik, GmbH, to which the present invention refers to. Thanks to the smaller radius of the supported deflecting shafts, also small pieces of another conveyor belt module can be transferred to the module presented here, without falling into the space between the deflecting points of the respective conveyor belts.

The deflecting rollers 22, 24 are driven respectively by driving means not illustrated on the figures and housed in the body 10. It preferably consists of an electric motor with suitable power transmission means. As indicated by the arrows F1, F2 in FIG. 1, the two conveyor belts 12, 14 are driven in opposite directions. The driving means can yet also be designed such that they allow a change of direction.

At least two not represented RFID-readers are furthermore integrated in the conveyor belt module. In FIG. 1, the areas under which both reading heads lie are referenced with number 44. It can be seen that one reading head lies respectively under each conveyor belt 12,14, such that it can read data from an RFID transponder attached to a work piece carrier 50, when the work piece carrier 50 goes on one auf the conveyor belts 12, 14. Additionally, or instead of the RFID reading heads, other sensors can be integrated into the conveyor belt module, such as e.g. inductive or capacitive sensors, light sensors etc.

FIG. 2 shows the conveyor belt illustrated in FIG. 1 from another perspective, that is to say from below, and one recognises a connecting plate 30, which stretches laterally over both conveyor belts from one side wall 11 of the body 10 to the other 13. On this plate, different connection elements 32, 34, 36 are foreseen, through which the conveyor belt module can be connected to a conveyor system or a production line. Connection pins 32 and centring bushings 34 are used in order to establish a mechanical connection and for a correct alignment of the module with respect to other similar modules or miscellaneous elements of a production line. Moreover, electrical contact plugs 36 are foreseen, which can serve not only for the connection to a network but also for energy supply, e.g. for the driving.

The conveyor belt module can thus be supplied with energy from the outside, and can exchange information and control signals over a network with other elements of a production line or with an external control unit.

It should be appreciated that the variant embodiments shown in the figures only serve the purpose of illustrating the invention as defined in the claims, and should in no way be understood as limitative. In particular, it is not necessary at all that the conveyor belt module according to the invention comprises two conveyor belts. A module with one conveyor belt only, which is driven around one deflecting roller and another deflecting element, such as e.g. the above mentioned thin deflecting shafts, is also comprised within the scope of the invention.

### REFERENCES LIST

10 Body
11 Side wall of the body
12 Conveyor belt
13 Side wall of the body
14 Conveyor belt
16 Boudary bar
18 Boudary bar
20 Transfer tongue
21 Transfer tongue
22 Deflecting roller
24 Deflecting roller
26 Deflecting roller
28 Deflecting roller
30 connecting plate
32 connection pin
34 centring bushing
36 electrical contact plug
44 place where the sensor is disposed
50 work piece carrier
F₁ conveying direction
F₂ conveying direction

What is claimed is:

1. A conveyor belt module with a body on which at least a deflecting roller and another deflecting element are rotatably mounted, around which a conveyor belt is guided, as well as drive means for driving at least the deflecting roller that is arranged in the body (, whereby the module further comprises mechanical and electrical connection elements for connecting the module to a conveyor system or a production line, and also comprises at least a sensor, that is arranged under the conveyor belt such that the objects which are to be transported on the conveyor belt can be detected with the help of the sensor.

2. The conveyor belt module according to claim 1, wherein it comprises a plurality of sensor, particularly at least an RFID-reader and/or at least another sensor.

3. The conveyor belt module according to claim 2, wherein the conveyor belt winds around a thin deflecting shaft compared to the diameter of the deflecting rollers, on at least on side of the module so as to form a transfer tongue.

4. The conveyor belt module according to claim 3, wherein the deflecting shaft is firmly clamped in the body on both sides outside the conveyor belt, and that spaced apart sliding bushings are rotatably mounted on the deflecting shaft, wherein the deflecting shafts are supported on support elements intervening between the sliding bushings.

5. The conveyor belt module according to claim 4, wherein the sliding bushings are made of plastic, metal coated with PTFE and/or graphite or bronze.

6. The conveyor belt module according to claim 1, wherein it has at least a second deflecting roller and another second deflecting element, around which a second conveyor belt is guided, which runs substantially parallel to the first conveyor belt.

7. The conveyor belt module according to claim 6, wherein it has second drive means for driving at least the second deflecting roller of the second conveyor belt.
